(19) United States
(12) Patent Application Publication
(10) Pub. No.: US 2006/0218592 A1
(43) Pub. Date: Sep. 28, 2006

(54) Method and apparatus for enabling direct response marketing

(75) Inventor: Reno R. Rolle, Ojai, CA (US)

Correspondence Address: REED SMITH, LLP, TWO EMBARCADERO CENTER, SUITE 2000, SAN FRANCISCO, CA, 94111, US

(73) Assignee: STUDIO STORE DIRECT, INC.

(21) Appl. No.: 11/147,064

(22) Filed: Jun. 7, 2005

Related U.S. Application Data
(60) Provisional application No. 60/583,366, filed on Jun. 29, 2004.

(51) Int. Cl. H04N 5/445; G07F 7/00; H04N 7/173; G06F 13/00; G06F 3/00; G06F 17/30; H04N 7/16; G06Q 30/00

(52) U.S. Cl. 725/60; 725/135; 705/26; 705/27; 725/109; 725/110; 725/112; 725/61

(57) ABSTRACT

A method and apparatus for enabling and facilitating direct response marketing of products. A method includes providing product marketing program content, providing a reference to the product marketing program in the entertainment program, such that by selecting the reference, a viewer can view the product marketing program content, providing contact information for sales service in the product marketing program content, wherein the contact information in the product marketing program content allows a viewer to purchase a desired product, and providing sales service to facilitate the viewer's purchase. The entertainment program and product marketing program may be stored on an optical disk, such as a DVD.

This application claims the benefit of U.S. Provisional Application No. 60/583,366, filed Jun. 29, 2004, entitled OPTICAL DISK METHOD AND SYSTEM ENABLING DIRECT RESPONSE MARKETING, the disclosure of which is herein incorporated by reference.

### BACKGROUND OF THE INVENTION

1. Field of the Invention

The present invention relates to a method and apparatus for enabling direct response marketing.

2. Description of the Related Art

The direct response television (DRTV) industry, consisting of long-form (infomercial) productions, short-form commercials and live home shopping channels, is one of the fastest growing segments of the retailing industry. This marketing medium produces immediate, measurable results and in 2003, the Electronic Retailing Association (ERA) estimated DRTV generated revenues of $154 billion dollars.

It is interesting to note that the ERA study concluded that consumers who purchase via DRTV retailing channels overall prefer the experience to shopping in stores.

The single most challenging aspect of this industry is the cost of television media. In the vast majority of cases the cost proves prohibitive and allows only a very few select programs to ever see successful runs. The extreme cost of media also dictates high margin requirements and leaves the marketing company with very little room for product cost.

Successful DRTV shows are far and few between. While a hit infomercial or spot can generate staggering sales numbers, the vast majority of shows produced never see the light of day. Producing a hit show requires an illusive blend of art and science perfected very rarely and by only a small handful of industry experts. Novices enter the space frequently and learn very quickly that there are few businesses that will burn hopes and money faster than DRTV.

In 2003 total sales and rental revenue for DVD entertainment content exceeded $21 billion dollars. The ancillary revenue generated through sales of licensed merchandise is equally impressive but falls short of the potential target. These consumers have elected to buy or rent a DVD to enjoy in the privacy of their homes. As such, they have expressed an obvious interest or affinity for the particular film, its characters, the genre and potentially related merchandise.

### SUMMARY OF THE INVENTION

In general, the present invention is a method and apparatus for enabling and facilitating direct response marketing. A method according to the present invention includes providing product marketing program content, providing a reference to the product marketing program in the entertainment program, such that by selecting the reference, a viewer can view the product marketing program content, providing contact information for sales service in the product marketing program content, wherein the contact information in the product marketing program content allows a viewer to purchase a desired product, and providing sales service to facilitate the viewer's purchase.

An alternate method of the present invention includes displaying a first program having entertainment content, providing a second program having product information content of products, displaying a reference to the second program in the first program; and providing purchase information in the second program to allow a viewer to purchase the products, wherein when a viewer selects the reference in the first program, the second program is displayed.

An apparatus according to the present invention includes a data storage media having entertainment program content, product marketing program content advertising products related to the entertainment program content, and contact information for sales service in the product marketing program content, wherein the contact information in the product marketing program content allows a viewer to purchase a desired product advertised in the program marketing program content.

One embodiment of the present invention provides for the presentation of video entertainment content, such as a movie, and direct response merchandising information, stored on an optical disk, such as a DVD. The optical disk includes encoded video data, such as a movie. In addition, the optical disk system allows playback of a direct response show or a multi-media catalog, which offers various merchandise for sale, including merchandise related or unrelated to the movie, merchandise related to the movie studio, and/or merchandise identified as being appropriate for sale and/or cross-sell to consumers of the entertainment. The optical disk system storing the entertainment content is distributed to consumers who have requested the particular video entertainment content.

Preferably, the direct response show provides a telephone number for the consumer to call to request the merchandise. One or more embodiments of the system and method allow the user allowing to select a particular merchandise item, for example via a URL link, and to communicate the potential direct purchase response via the Internet.

One or more embodiments of the optical disk system include a memory unit coupled to a disk drive unit and an input device. The disk drive unit retrieves into the memory the encoded video data, encoded direct response video data, and navigation data stored upon an optical disk (e.g., a DVD). The encoded video data may be, for example, a recorded presentation such as a movie. In response to user input, the memory unit retrieves the navigation data stored on the optical disk, and from the navigation data stored on the disk, retrieves the encoded video data and the encoded direct response video data.

In another embodiment, the entertainment content is displayed on a television channel or via an Internet connection. A link is included in the entertainment program to a parallel direct response show broadcast on another channel, or available from the Internet connection.

The present invention thus allows the user to experience the direct response show, in addition to selected portions of a presentation, e.g., favorite movie scenes, and, according to alternate embodiments, to respond to the direct response show either with or without having to dial a telephone.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is an illustration of one embodiment of the present invention, utilizing a DVD player, television display, and telephone for direct response marketing;

FIGS. 2(a) and 2(b) illustrate the operation of the system according to FIG. 1;

FIGS. 3(a) and 3(b) illustrate alternative embodiments of the present invention;

FIG. 4 is an illustration of a computer appropriate for use in connection with one or more embodiments of the present invention; and

FIG. 5 is a block diagram illustrating the internal hardware of the computer of FIG. 1.

### DETAILED DESCRIPTION OF THE INVENTION

The following description is provided to enable any person skilled in the art to make and use the invention and sets forth the best modes contemplated by the inventor for carrying out the invention. Various modification, however, will remain readily apparent to those skilled in the art. Any and all such modifications, equivalents and alternatives are intended to fall within the spirit and scope of the present invention.

In general, the present invention is a new marketing process for home video and consumer products. One or more aspects of the present invention provide for direct response marketing via DVDs that exploit the underutilized media available on optical disks. Various consumer products both related and related to the entertainment content, licensed merchandise, as well as other DVD offers and applicable studio products are featured in a dynamic Direct Response program. These shows are embedded directly into the actual entertainment DVD. Consumers can opt-in by selecting, for example, a reference icon on the menu screen and purchase products directly from the comfort of their own homes. Consumers are directed by Calls To Action (CTAs) to (toll-free) telephone lines operated by support staff who capture and process the orders while also up-selling additional items.

The revenue potential for sales of consumer merchandise using this method is enormous. The typical cost of media to reach consumers whether through television, print, radio or any other means, is the single most limiting factor in any consumer product-marketing endeavor. With this method, not only is there no cost of media to reach highly targeted and impressionable consumers, the buyers are in essence, purchasing and watching the DVD in exchange for the promise of entertainment and direct access to selected product offerings.

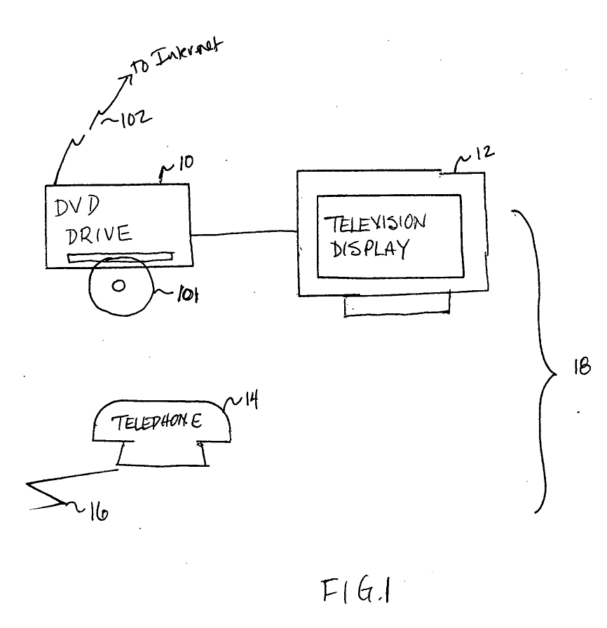

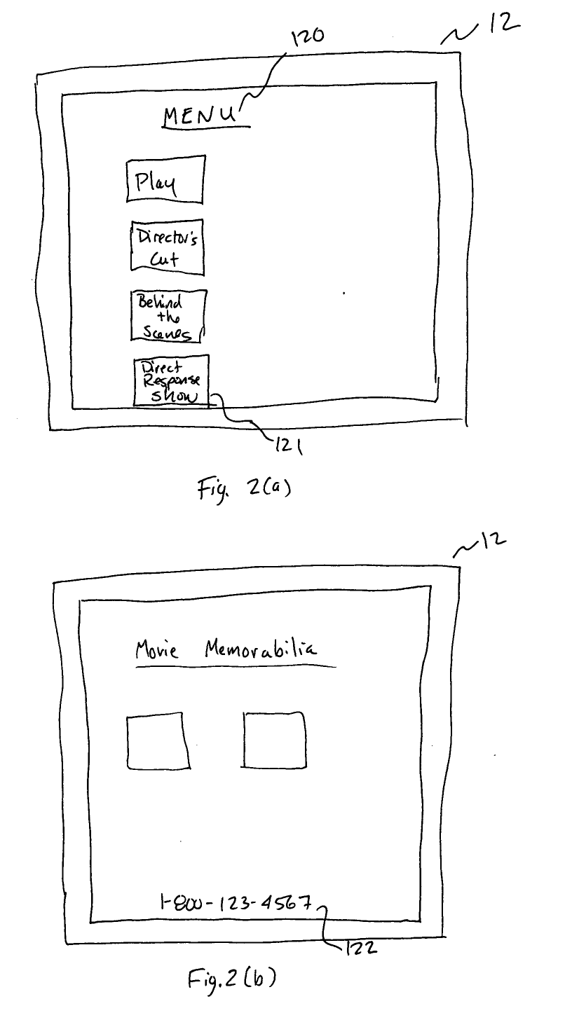

Referring now to FIG. 1, the direct response DVD system 18 according to one or more embodiments of the present invention includes, e.g., a DVD drive 10 running a DVD 101 or other type of optical disk, in communication with a television display 12. The DVD 101 is provided, including entertainment content, such as a movie. The consumer views the television display 12, on which is displayed the movie or other entertainment content, including, a menu 120, as shown in FIG. 2(a). In the main menu 120 there is a reference icon 121 to direct response content, such as a recorded direct response infomercial or a multi-media electronic catalog. The consumer selects the icon 121, causing the direct response show to be accessed by the DVD drive 10 and displayed, as shown in FIG. 2(b). The direct response show provides a telephone number 122 for the consumer to utilize to request and/or order merchandise. A telephone 14 is utilized by the consumer to order the merchandise via a communication line 16. Alternatively, the direct response program could have a URL that allows the viewer to directly connect to a website via the Internet connection 102, and make a direct purchase the desired merchandise.

Thus, the present invention provides a method for allowing consumers to affirmatively “opt-in” to a direct response marketing program, where the consumer has already expressed an interest in the underlying entertainment program content.

To assist with tracking consumer information, the direct response show on the DVD may include special codes or “coupons” that provide for discounts or extra benefits when a purchase is made. This information can be used to analyze the effectiveness of different sales and/or marketing channels.

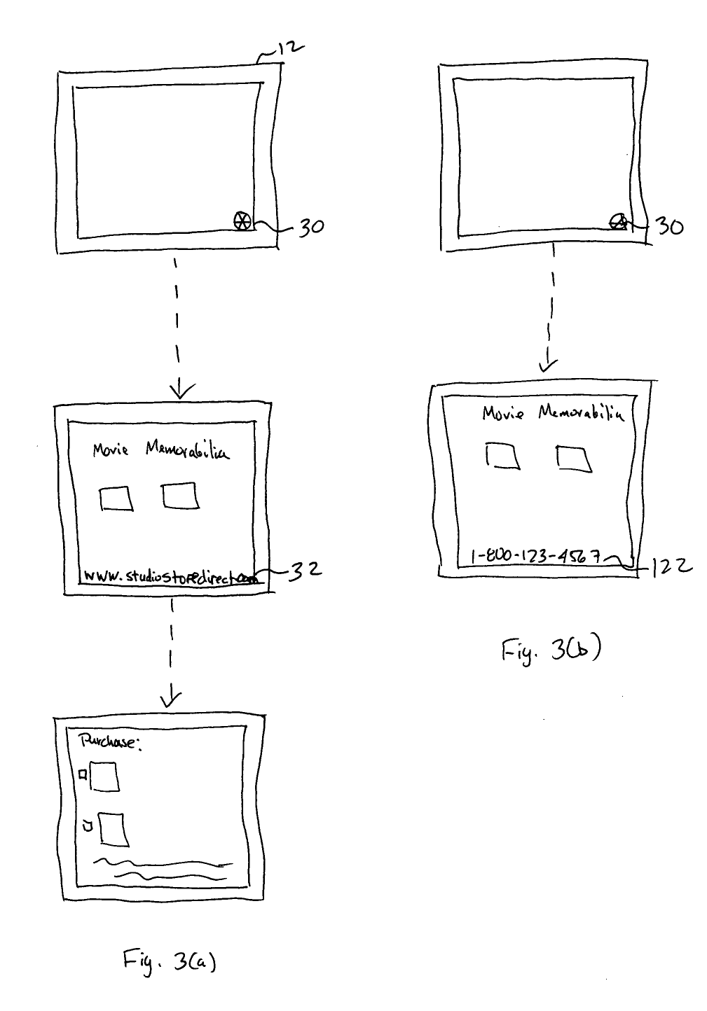

While the present invention is particularly suited to take advantage of the unique characteristics of the convenient DVD format, the present invention may also be utilized in conjunction with video-on-demand, Internet downloads and/or steaming video, as well as standard television broadcasts. For example, as shown in FIG. 3(a), a standard television program or an Internet video can be displayed on display 12. A viewer can then select an icon 30 that causes the display to show a direct response program that is related to the original entertainment programming. From the direct response show, the viewer may then select a displayed URL 32, which then displays a website where the viewer can make a direct purchase. Alternatively, the viewer may place a telephone call, as shown in FIG. 3(b).

The “parallel” direct response show may be broadcast simultaneously with the original program, or only be activated when a viewer selects the associated icon. In addition, the icon displayed on the original broadcast or video, whether a link to another channel, download, or URL, can be an “indirect reference.” In other words, instead of embedding a “hard link” to a specific website which may change, for instance, the link can be to main site, which in turn can forward the request to another site. Such an arrangement is useful to track access from different sources, for referral and revenue sharing, etc. This configuration also allows for different channels, sites, etc. for different markets. Moreover, two or more levels of indirection may be used, depending upon the business arrangement of the suppliers, distributors, and sellers.

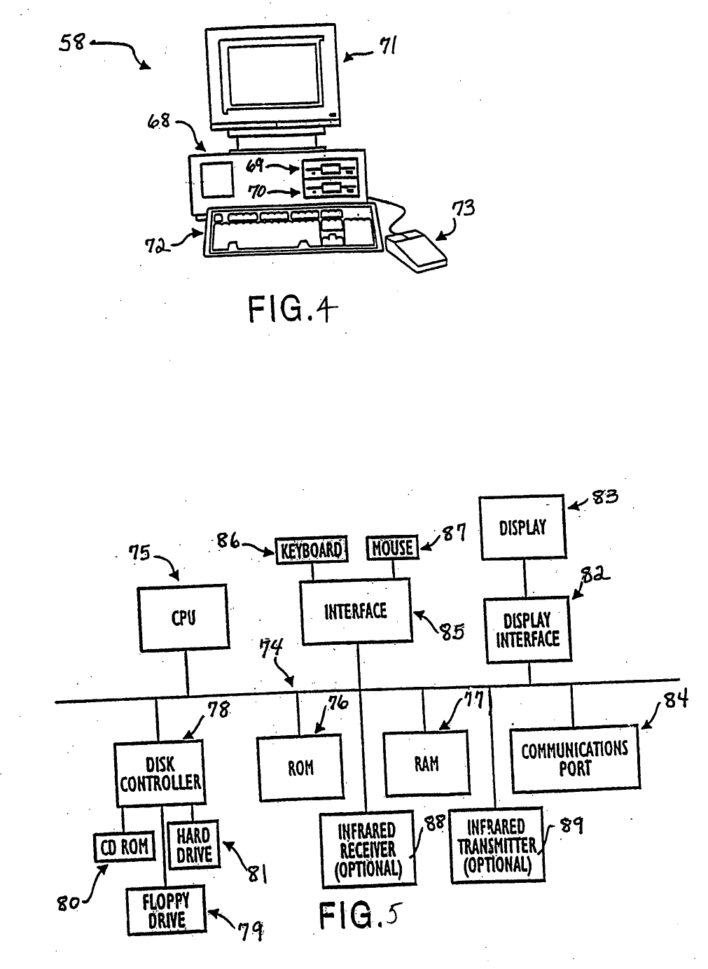

FIG. 4 is an illustration of a computer 58 used for implementing the computer processing in accordance with a computer-implemented embodiment of the present invention. The procedures described above may be presented in terms of program procedures executed on, for example, a computer or network of computers.

Viewed externally in FIG. 1, computer 58 has a central processing unit (CPU) 68 having disk drives 69, 70. Disk drives 69, 70 are merely symbolic of a number of disk drives that might be accommodated by computer 58. Typically, these might be one or more of the following: a floppy disk drive 69, a hard disk drive (not shown), and a CD ROM or digital video disk, as indicated by the slot at 70. The number and type of drives varies, typically with different computer configurations. One or more of the disk drives 69, 70 are, in fact, options, and for space considerations, may be omitted from the computer system used in conjunction with the processes described herein. The digital video disk may communicate via an optional DVD player, communicating directly or indirectly with the computer 58.

Computer 58 also is connected directly or indirectly to a display 71 upon which information may be displayed. The display is optional for the computer used in conjunction with the system described herein. Alternatively, a television or similar large display device may be provided. A keyboard 72 and/or a pointing device 73, such as a mouse 73, may be provided as input devices to interface with central processing unit 68. To increase input efficiency, keyboard 72 may be supplemented or replaced with a scanner, card reader, remote control unit, or other data input device. The pointing device 73 may be a mouse, touch pad control device, track ball device, or any other type of pointing device.

FIG. 5 illustrates a block diagram of the internal hardware of the computer of FIG. 1. CPU 75 is the central processing unit of the system, performing calculations and logic operations required to execute a program. Read only memory (ROM) 76 and random access memory (RAM) 77 constitute the main memory of the computer.

Disk controller 78 interfaces one or more disk drives to the system bus 74. These disk drives may be floppy disk drives such as 79, or CD ROM or DVD (digital video/versatile disk) drives, as at 80, or internal or external hard drives 81. As previously indicated these various disk drives and disk controllers are optional devices.

A display interface 82 permits information from bus 74 to be displayed on the display 83. Again, as indicated, the display 83 is an optional accessory for a central or remote computer in the communication network, as are infrared receiver 88 and transmitter 89. Communication with external devices occurs using communications port 84.

In addition to the standard components of the computer, the computer may also include an interface 85, which allows for data input through the keyboard 86 or pointing device, such as a mouse 87.

As one example, the information system may include a general purpose computer, a specially programmed special purpose computer, a DVD player, and/or a television. The computer 58 may include a television tuner card allowing it to receive and view television signals, or video signals from peripheral players. The computer 58 may be connected to the Internet or other network to send and receive data. Similarly, the display 12 may include component parts allowing it to access the Internet or other local area networks from which it can send and/or receive data. Computer 58 or television 12 may be implemented as part of a distributed computer system rather than a single computer or DVD player. Similarly, a communications link may be World Wide Web, a modem over a POTS line, and/or any other method of communicating between computers and/or users. Moreover, the processing could be controlled by a software program on one or more computer system or processors, or could even be partially or wholly implemented in hardware.

Further, the invention is not limited to particular protocols for communication. Any appropriate communication protocol may be used.

One or more displays for the system may be developed in connection with convention display formats utilized in connection with distribution of movies on DVDs. Although this is the preferred display format, it is possible to utilize alternative display formats for displaying a report and obtaining user instructions.

The invention has been discussed in connection with particular examples. However, the principles apply equally to other examples and/or realizations. Naturally, the relevant data may differ, as appropriate.

Further, this invention has been discussed in certain examples as if it is made available by a provider to a single customer with a single site. The invention may be used by numerous customers, if preferred. Also, the invention may be utilized by customers with multiple sites and/or agents and/or licensee-type arrangements.

The system used in connection with the invention may rely on the integration of various components including, as appropriate and/or if desired, hardware and software servers, applications software, database engines, server area networks, firewall and SSL security, production back-up systems, and/or applications interface software. The configuration optionally is network-based and optionally utilizes the Internet as an exemplary primary interface with the customer when the customer responds to the direct response marketing.

The system may store collected information regarding customers and responses to the direct marketing in a database. An appropriate database may be on a standard server, for example, a small Sun Sparc or other remote location. The database is optionally an MSQL, MYSQL, mini sequel server MiniSQL, or Oracle. Information is stored in the database, and optionally stored and backed up by a back-up server, periodically or a-periodically, for example, every night along with all other data in the servers that are behind the corporate firewall into a back-up storage facility. Back-up storage facility comprises, for example, one or more tape silos that are also used to back up the entire network every night.

The various databases may be in, for example, a UNIX format, but other standard data formats may also be used. Windows NT, for example, is used, but other standard operating systems may also be used. Optionally, the various databases include a conversion system capable of receiving data in various standard formats.

From the user's perspective, according to some embodiments the user may access the public Internet or other suitable network and look at its specific information relating to direct marketing purchases at any time from any location as long as it has Internet or other suitable access. For example, the user opens its standard web browser, goes to the address that is specified for its load data, and optionally fills out a user ID to log on, and a password to identify it as the specific customer of that particular information.

When Internet-enabled, the user and, indeed, multiple users concurrently can look at the same direct response information. Advantageously, having this system on the Internet enables users at various locations throughout the country or the world, to respond to the direct response marketing at the same time and enter into a discussion or talk group as to what they are seeing, what it means, and maybe what they can do with that information.

The present invention may be incorporated into a readable media, such as a DVD. Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, micro-drive, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Data used by the software may be retrieved from different sources (local or remote) and either permanently or temporarily stored (before, during, or after any processing) by utilizing any of text files, delimited files, database(s), or other storage techniques. Ultimately, such computer readable media further includes software for performing the present invention, as described above.

Included in the programming (software) of the general/specialized computer or microprocessor are software modules for implementing the teachings of the present invention, including, but not limited to, finding updateable areas of a program, transferring components from a remote server to a program, managing areas/locations with a remote program, including organizing displays and facilitating purchase of items displayed, installing add-on components into a program, and the display, storage, or communication of results according to the processes of the present invention.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method for direct response marketing, the method comprising:
providing entertainment program content;
providing product marketing program content;
providing a reference to the product marketing program in the entertainment program, such that by selecting the reference, a viewer can view the product marketing program content;
providing contact information for sales service in the product marketing program content, wherein the contact information in the product marketing program content allows a viewer to purchase a desired product; and
providing sales service to facilitate the viewer's purchase.

2. The method of claim 1, wherein the reference is provided in an on-screen menu associated with the entertainment program.

3. The method of claim 1, wherein the product marketing program content is a multi-media electronic catalog.

4. The method of claim 1, wherein the product marketing program content is a live or recorded broadcast of product descriptions and/or demonstrations of merchandise.

5. The method of claim 1, wherein the contact information is a telephone number.

6. The method of claim 5, wherein the sales service is a customer service operator.

7. The method of claim 1, wherein the contact information is an Internet Uniform Resource Locator (URL).

8. The method of claim 7, wherein the sales service is an Internet server, such that when a viewer selects the URL, a product sales website is displayed.

9. The method of claim 1, wherein the product marketing program content includes a discount coupon number to allow a user to purchase a product at a discount.

10. The method of claim 6, wherein the entertainment program and product marketing program are stored on a DVD, and the reference to the product marketing program is in a main menu of the contents of the DVD instead of in the entertainment program.

11. A method for marketing products related to content of an entertainment program, the method comprising:
displaying a first program having entertainment content;
providing a second program having product information content of products;
displaying a reference to the second program in the first program; and
providing purchase information in the second program to allow a viewer to purchase the products;
wherein when a viewer selects the reference in the first program, the second program is displayed.

11. The method of claim 10, wherein the first program is a television program, and the reference is an indirect reference to another television channel.

12. The method of claim 11, wherein the reference is an indirect reference to an Internet website, such that when the viewer selects the reference, a product sales website is displayed.

13. The method of claim 10, wherein the purchase information is a telephone number.

14. The method of claim 10, wherein the purchase information is an Internet URL.

15. The method of claim 10, wherein the second program is displayed simultaneously with the first program.

16. The method of claim 10, wherein the second program is not displayed until a viewer selects the reference.

17. A data storage media comprising:
entertainment program content;
product marketing program content advertising products; and
contact information for sales service in the product marketing program content, wherein the contact information in the product marketing program content allows a viewer to purchase a desired product advertised in the program marketing program content.

18. The data storage media of claim 17, wherein the contact information is a telephone number and the product marketing program content is selected via a contents menu for the data storage media.

19. The data storage media of claim 18, wherein the contact information is an Internet URL and when a viewer selects the URL, a sales website is displayed.
